(19) United States
(12) Patent Application Publication
(10) Pub. No.: US 2015/0138765 A1
(43) Pub. Date: May 21, 2015

(54) POPCORN MACHINES WITH LIGHTING EFFECTS AND METHODS OF USING THE SAME

(71) Applicant: Paramount Inc., Wilmington, DE (US)

(72) Inventor: Nathan Johnson, Western Springs, IL (US)

(21) Appl. No.: 14/518,801

(22) Filed: Oct. 20, 2014

Related U.S. Application Data
(60) Provisional application No. 61/906,158, filed on Nov. 19, 2013.

(51) Int. Cl. F21V 23/00; H05B 33/08; H05B 37/02; A23L 1/18; F21K 99/00

(52) U.S. Cl. CPC F21V 23/003; A23L 1/1812; F21K 9/30; H05B 37/0236; H05B 33/0872
USPC 362/231; 362/234

(57) ABSTRACT

Popcorn machines having lighting effects provided by use of at least one LED light source are disclosed.

### CROSS-REFERENCE TO RELATED APPLICATION

This application claims the benefit of U.S. Provisional Patent Application Ser. No. 61/906,158, filed Nov. 19, 2013, the disclosure of which is hereby incorporated by reference in its entirety.

### BACKGROUND OF THE INVENTION

1. Field of the Invention

The present invention generally relates to corn popping apparatus, such as popcorn machines, and more particularly to improvements relating to lighting within such popcorn machines and methods of using new lighting apparatus.

2. Discussion of the Prior Art

Corn popping apparatus may take various forms, but when intending to make repeated batches of popped corn, it is common to utilize what generally is known as a popcorn machine, with such a machine having a housing or cabinet, which includes a cavity in which a heated kettle assembly is located to pop the corn and in which the popped corn is at least collected and temporarily stored. The housing may include glass or transparent side panels through which the kettle assembly and popped corn within the cavity may be viewed. This may serve to drive desirability for the popped corn, while also displaying the quantity of popped corn available.

Such popcorn machines may be configured to stand alone, such as when placed on a counter or table top. The machines also may be configured to be placed on top of a cart, which may for decoration have a nostalgic appearance, or a cart may be incorporated into a base unit of a machine. A cart may be used for portability of the machine and/or to provide a more fanciful display. These types of machines may be in configurations and of sizes that would be suitable for personal or home use. They also may be somewhat larger, such as for use in a business in any of a number of settings, for example, in waiting areas of businesses that do not otherwise serve food, such as automobile dealerships or banks, or in restaurants, or establishments that might be called a bar or tavern. Frankly, they may be used in any suitable environment having a power outlet or socket and where it might be desirable to be able to enjoy freshly popped corn. The inventive aspects disclosed herein can be applied to machines of these various sizes, and some may be useful even with larger machines that are intended for extensive production, such as in movie theaters or other vending environments.

The common structure for the housing of many popcorn machines generally includes a base unit, four corner columns, glass or other transparent side panels, and an upper unit. The side panels typically are fixed between the columns on three sides of the housing, while on a fourth side there may be hinge assemblies for pivotal connection of one or more side panels that serve as operator access doors.

The base unit or upper unit may include a controller and/or switches to enable an operator to manage the supply of power to the machine's electrical components. For instance, the base unit also may include a warming element below a floor of the cavity, to keep the popped corn warm. Power may be supplied to the upper unit for connection to one or more additional electrical components, such as to a kettle assembly and its electric heating element, to one or more lights, whether mounted within the upper unit in a manner to illuminate within the cavity or to illuminate signage on one or more faces of the upper unit, and/or to a fan or blower that may be used to vent or exhaust from the cavity steam or vapors that may be generated during or after the corn cooking process.

Indeed, to light the inside of the cavity of a popcorn machine, it has been common to use an incandescent light bulb. Some popcorn machines even use a light bulb in the form of a heat lamp, if it is desired to provide heat for warming from above the popped corn. However, depending on the size, capacity and type of use contemplated, some popcorn machines will employ a lower heating element that provides warming heat from below the popped corn. In any event, an incandescent light bulb or heat lamp will generate significant heat. Accordingly, popcorn machines tend to require that the light bulb be shielded from touch or contact by an operator and from the oil used in the cooking of the popped corn. Even when shielded, an incandescent bulb is susceptible to breakage, and if broken, creates a significant safety and cleaning issue.

Unfortunately, heat shields for incandescent light bulbs or heat lamps also typically are constructed of stamped sheet metal, which can have relatively sharp edges and which then needs to be configured for mounting to the ceiling (or bottom surface of the upper unit) of the cavity, such as by rivets, screws, welding or other means of mechanical fastening. Also, use of a popcorn machine tends to cause the accumulation of debris associated with popped corn, whether bits of popped corn, unpopped kernels, oil residue, salt, or the like. As such, a heat shield presents an awkward obstacle to cleaning the surfaces within the cavity of the housing as an operator reaches inside of the cavity through an operator access door on one side of the machine. This can be difficult, as the operator must reach through the machine to reach the opposed side walls, the ceiling and the floor of the cavity (or top surface of the base unit), while working around the heat shield and a protruding light bulb, which also may be very hot. The fixed location of a heat shield toward a corner and at the ceiling of a cavity, also tends to make it difficult for an operator to clean around the shield and bulb. Indeed, reaching into the cavity of a machine when surfaces may be very hot, and cleaning around a light bulb and heat shield can be awkward and potentially hazardous, especially if an operator is not particularly attentive and careful.

The above-mentioned types of shortcomings of popcorn machines have been present for many years. The popcorn machines of the present disclosure address many of the aforementioned shortcomings, while providing advantages that enhance numerous aspects associated with displaying, operating and servicing popcorn machines.

### SUMMARY OF THE INVENTION

The purpose and advantages of the disclosed subject matter will be set forth in and apparent from the description and drawings that follow, as well as will be learned by practice of the claimed subject matter.

The present disclosure generally provides popcorn machines that seek to provide numerous advantages when using at least one LED light source for illuminating the cavity of the popcorn machine or otherwise providing lighting effects. An LED light source suitable for use in a popcorn machine can provide an extremely long life cycle, while utilizing less energy, and not generating much heat. Given that it remains essentially cool enough to touch, an LED light source does not require use of a heat shield. This permits use of fewer parts and reduced labor when constructing a popcorn machine because one need not provide a separate heat shield, fasteners and holes through the heat shield and the ceiling of the cavity for mounting, as well as the further labor to mount the heat shield.

The LED light source also optionally can be mounted flush with the ceiling, as opposed to extending downward into the cavity. This provides significant advantages when having to reach through the cavity to service components or when cleaning the interior surfaces of the cavity. The removal of a sheet metal heat shield and a hot light bulb significantly reduces the risks of injury, while permitting cleaning more promptly after use of the machine. In addition, the extended life of an LED light source and its lack of sensitivity to temperatures, humidity, jarring and bumping, should reduce the risk of breakage and the incidence of replacement, and may facilitate factory installation of the LED light source in a more sealed manner, that may not require servicing during the life of the popcorn machine.

With respect to cleanliness, while a light socket for an incandescent light bulb or heat lamp may include an aperture around the base of the bulb, the optional flush mounting of an LED light source also can be used to close off the area around the light source. This improved flush mounting prevents oily vapors or humidity within the cavity from making their way up and into the upper housing, where they generally are not beneficial to the equipment.

In addition, LED light sources can be selected to provide various lighting effects, such as the ability to change the color of the light, or to react to sound. For instance, an LED light source may permit a particular color of light to be chosen, which may help promote a holiday theme, or may be used in conjunction with a color of the machine to honor, for instance, the colors associated with a college or university. Similarly, the LED light source may be set to have the color change periodically, or fade from one to another, for entertainment. The ability to react to sounds can provide a lighting experience that will provide a strobe light effect when corn is popping, or other entertainment features, such as when following along with music.

It will be appreciated that the unique configurations of lighting for popcorn machines disclosed herein permit numerous advantages involving at least initial machine construction, energy use, safety, and ease of cleaning a popcorn machine. Thus, instead of experiencing the aforementioned disadvantages associated with use of an incandescent bulb or heat lamp and a heat shield, the popcorn machines of the present disclosure are intended to enhance the operator's experience by providing entertainment opportunities, as well as numerous advantages when operating, servicing or cleaning the inside of a popcorn machine.

The present disclosure also presents advantageous constructions that address lighting aspects that permit personalization of a machine and/or may enhance the ability of a popcorn machine to attract attention. Such constructions include lighting fixtures that do not simply shine an incandescent bulb within the housing to light the cavity where the corn is popped and temporarily stored. The lighting disclosed avoids creating significant heat or an obstruction within the cavity, while optionally providing a means of personalization or entertainment. Many of the aforementioned advantageous constructions may be incorporated together into original equipment popcorn machines, while some additionally may be utilized in an aftermarket manner, when applied to existing machines.

In a first aspect, the disclosure presents a popcorn machine that includes an upper unit spaced from and above a base unit, and a plurality of side panels that extend between the upper and base units and define a cavity, at least one LED light source within the popcorn machine and connected to the upper unit, wherein the LED light source provides light to the cavity.

In another aspect, the disclosure presents a method of providing lighting effects for a popcorn machine including the steps of: providing an LED light source connected to an upper unit of the popcorn machine, providing power to the LED light source, and setting the LED light source to provide at least one color of light.

In a further aspect, the disclosure presents a popcorn machine providing lighting effects that includes a housing further having an upper unit spaced from and above a base unit, and a plurality of side panels that together with the upper and base units define a cavity, and at least one LED light source configured to shine light into the cavity.

Thus, the present disclosure presents alternative constructions and configurations for popcorn machines that overcome many of the shortcomings of the prior art. Many of the teachings herein address aspects of prior art popcorn machines that have made such machines more problematic for cleaning or servicing, than desired.

It is to be understood that both the foregoing general description and the following detailed description are exemplary and provided for purposes of explanation only, and are not restrictive of the subject matter claimed. Further features and objects of the present disclosure will become more fully apparent in the following description of the preferred embodiments and from the appended claims.

### BRIEF DESCRIPTION OF THE DRAWINGS

In describing the preferred embodiments, reference is made to the accompanying drawing figures wherein like parts have like reference numerals, and wherein:

FIG. 1 is a front perspective view of a prior art popcorn machine that includes an incandescent light bulb and a heat shield.

FIG. 2 is a side perspective view of the prior art popcorn machine of FIG. 1.

FIG. 3 is a close up front perspective view of the incandescent light bulb and heat shield of the prior art popcorn machine of FIG. 1.

FIG. 4 is a close up side perspective view of the incandescent light bulb and heat shield of the prior art popcorn machine of FIG. 1.

FIG. 5 is a close up perspective view of a socket for the incandescent light bulb of the prior art popcorn machine of FIG. 1.

FIG. 6 is a front perspective view of an inventive popcorn machine having an LED light source.

FIG. 7 is a side perspective view of the popcorn machine of FIG. 6.

FIG. 8 is a close up front perspective view of the LED light source of the popcorn machine of FIG. 6.

FIG. 9 is a close up side perspective view of the LED light source of the popcorn machine of FIG. 6.

FIG. 10 is a close up perspective view of a connection to the LED light source of the popcorn machine of FIG. 6.

FIG. 11 is a front perspective view of a user operating a remote control device to control the LED light source of the popcorn machine of FIG. 6.

FIG. 12 is a front perspective view of an example LED light source such as is shown in the popcorn machine of FIGS. 6-11.

FIG. 13 is a side perspective view of an example LED light source such as is shown in the popcorn machine of FIGS. 6-11.

FIG. 14 is a perspective view of a remote control device for use with the LED light source of the popcorn machine of FIGS. 6-11.

It should be understood that the drawings are not to scale. While some mechanical details of a popcorn machines and other plan and section views of the particular components have not been included, such details are considered well within the comprehension of those of skill in the art in light of the present disclosure. It also should be understood that the claimed subject matter is not limited to the example embodiments illustrated.

### DETAILED DESCRIPTION OF THE PREFERRED EMBODIMENTS

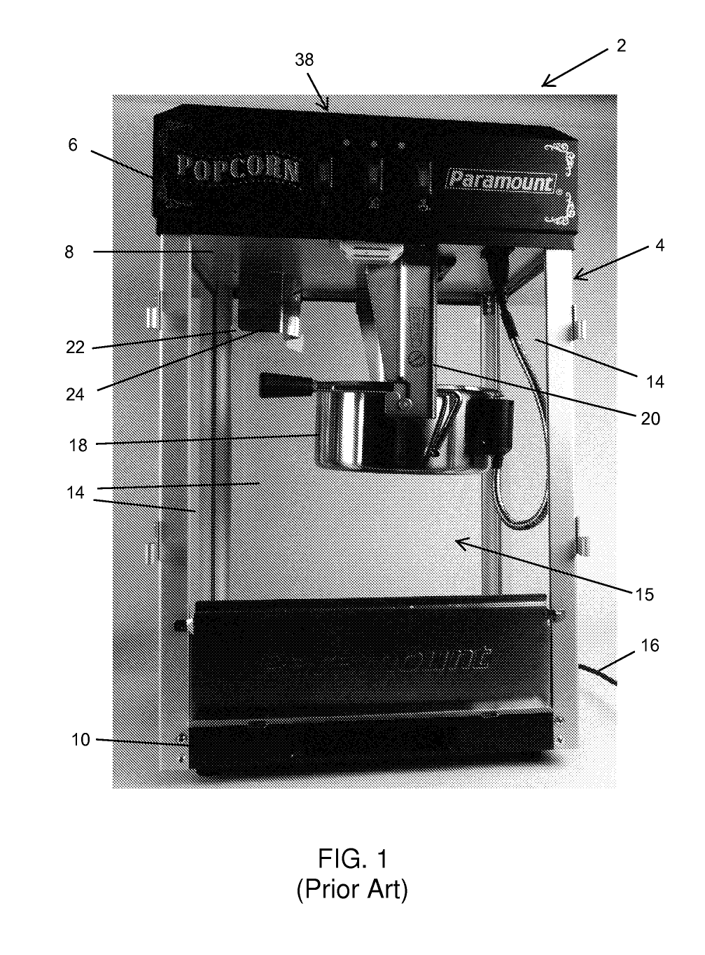

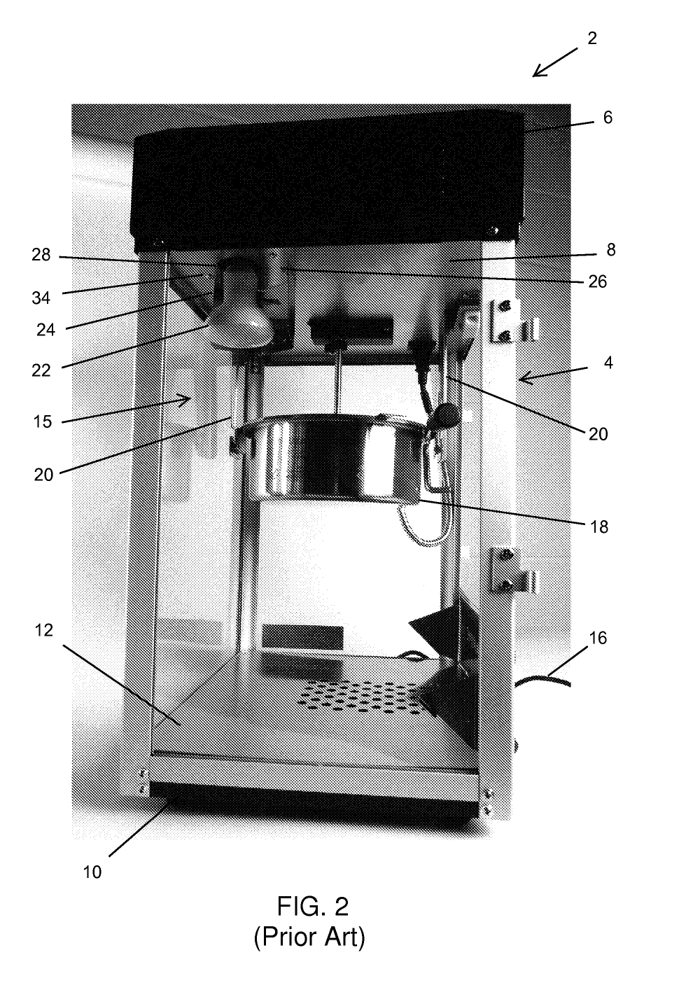

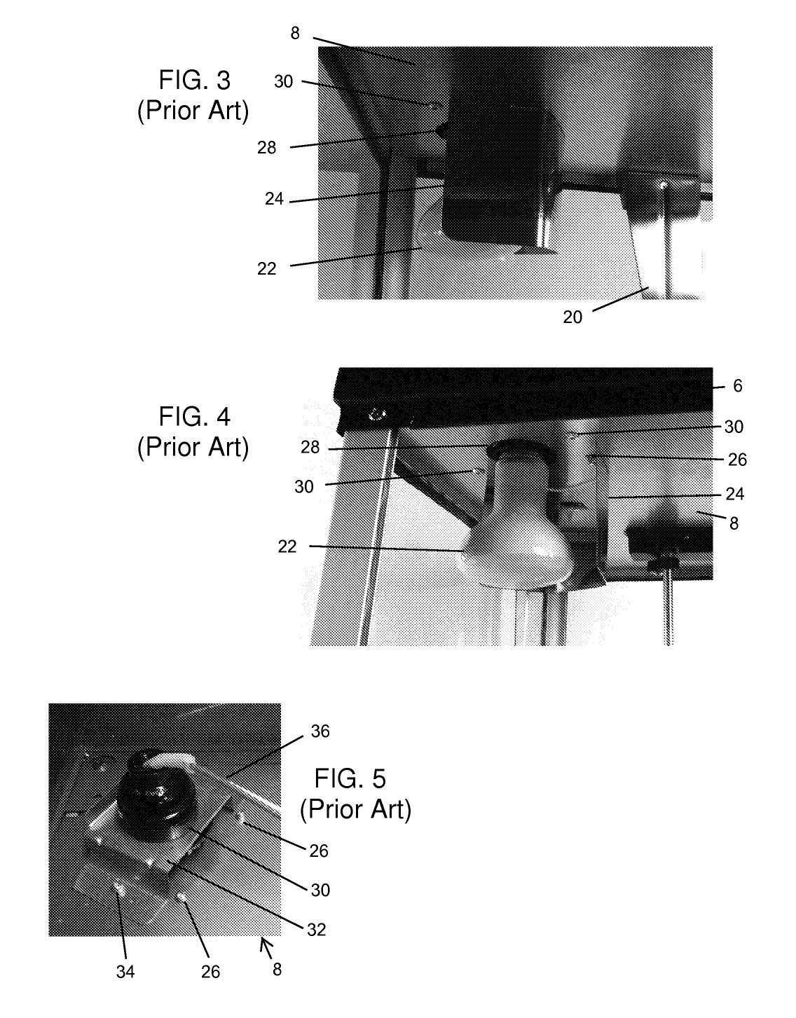

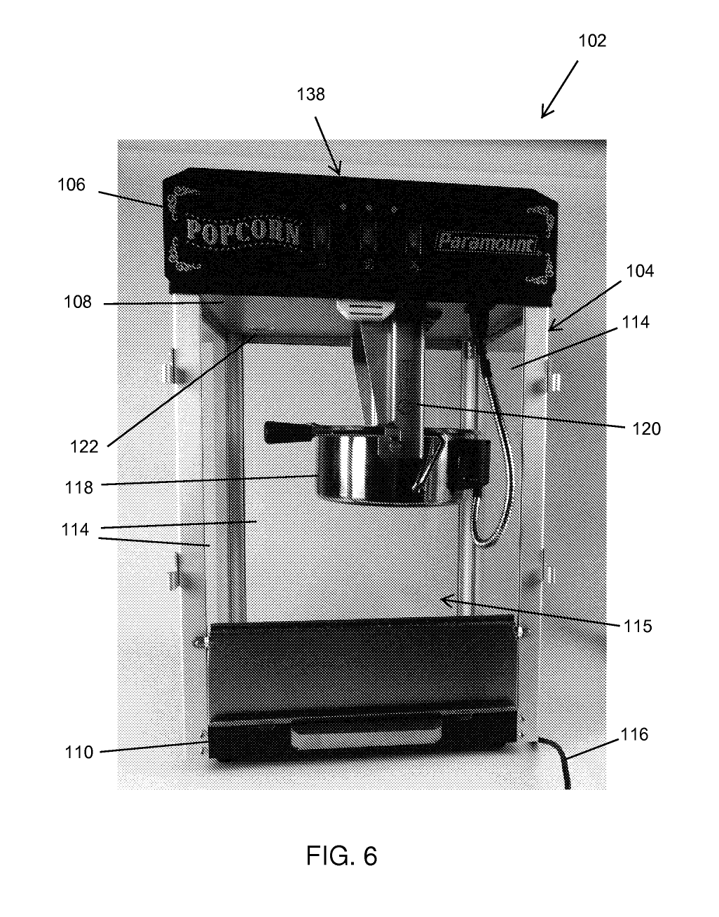

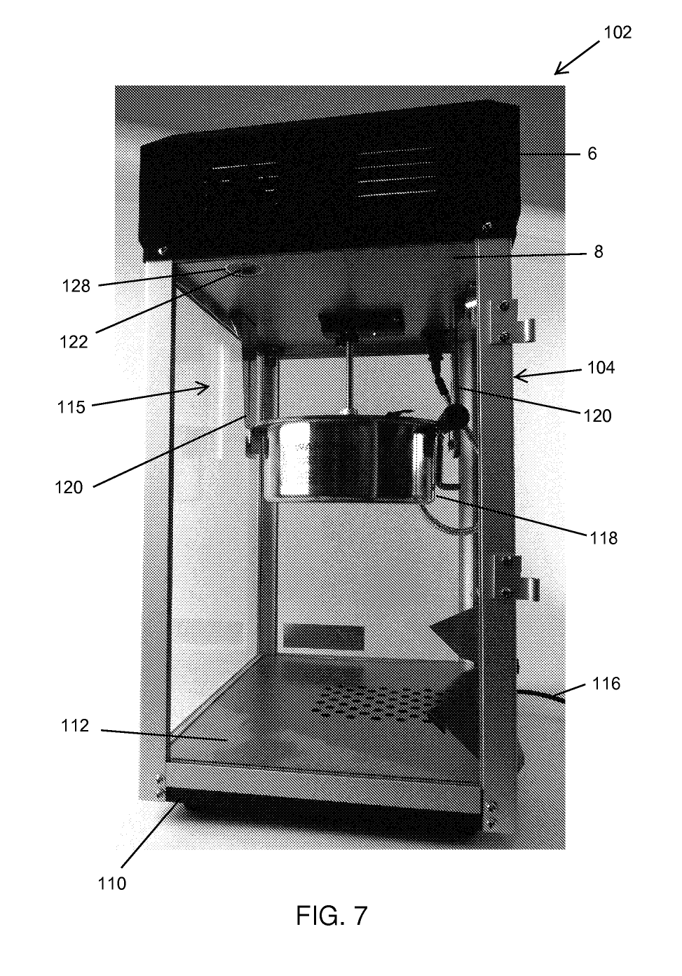

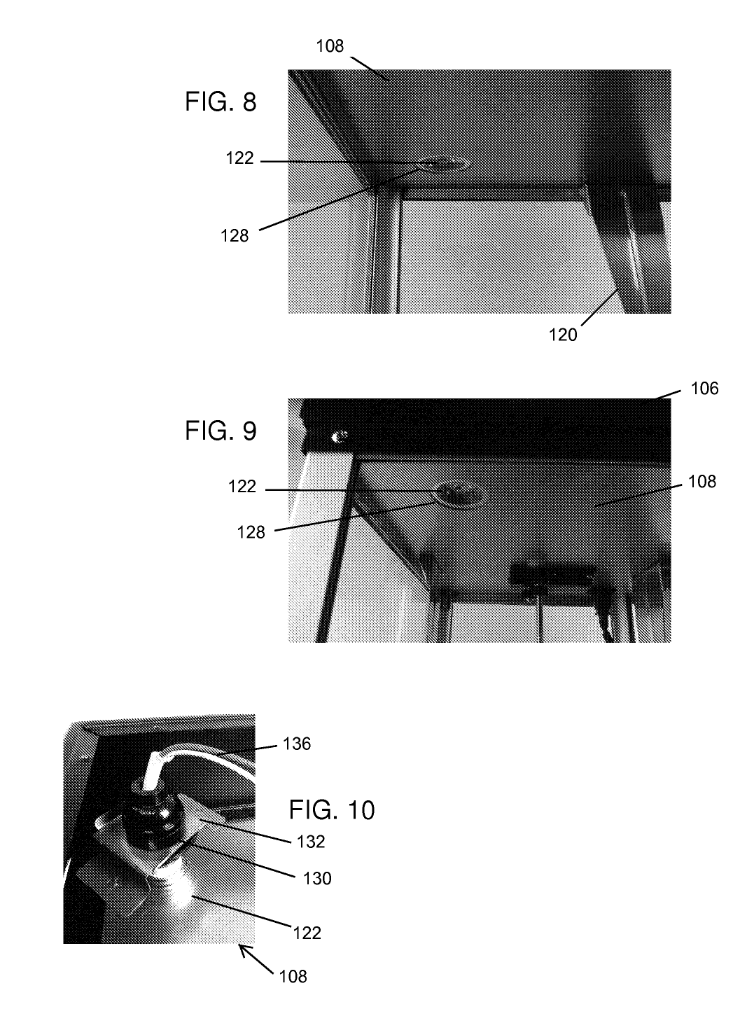

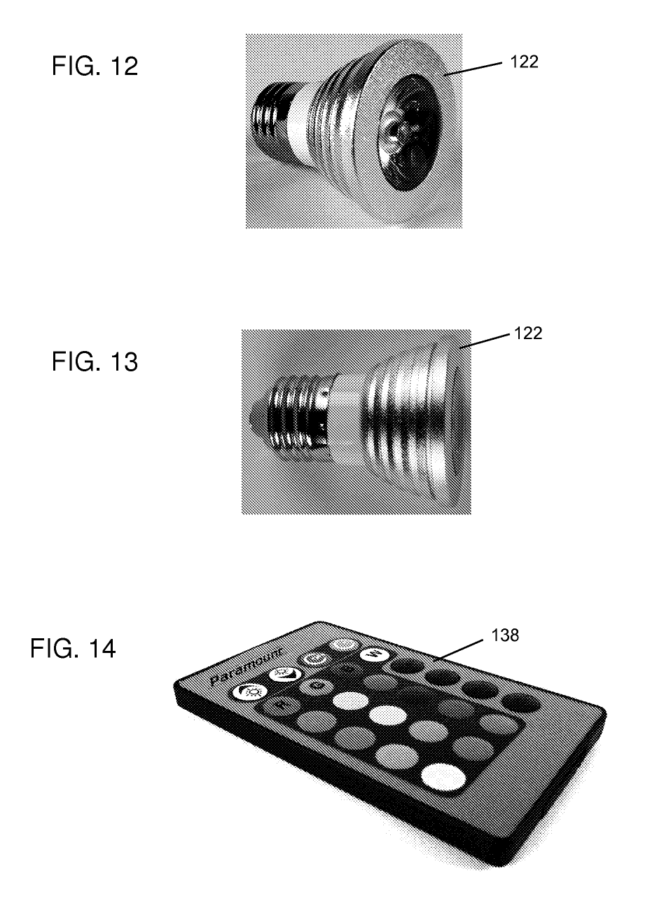

Referring generally to FIGS. 1-5, a prior art popcorn machine is shown. Disclosed in FIGS. 6-14 is a popcorn machine and components for the machine that provide an example of the types of apparatus that may include the inventive subject matter herein. It will be appreciated that popcorn machines of the present disclosure generally may be embodied within numerous configurations, having one or more of the advantageous features disclosed herein. Indeed, while acknowledging that all example configurations that may include the various advantageous features of popcorn machines and methods of making and using such machines need not be shown herein, it is contemplated that popcorn machines may incorporate various combinations of the advantageous features taught herein.

Turning to FIGS. 1-5, an example prior art popcorn machine 2 is illustrated. The popcorn machine 2 includes a housing 4, having an upper unit 6 having a lower surface 8, and a base unit 10 having an upper surface 12, as well as a plurality of side panels 14, which together define a cavity 15. Note that a pair of hinged doors that serve as the side panels on the front of the popcorn machine 2 and that are associated with the opening for the operator to reach into the cavity 15, have been removed from the popcorn machine 2 for enhanced viewing of the other components. The lower surface 8 of the upper unit 6 serves as a ceiling of the cavity 15, while the upper surface 12 of the base unit 10 serves as a floor of the cavity 15. A power cord 16 brings electricity to the popcorn machine 2 and is connected to the base unit 10.

Within the cavity 15 is a kettle assembly 18 for heating oil to cook the corn. The kettle assembly 18 hangs from kettle supports 20. The kettle supports 20 are connected to the ceiling 8 of the cavity 15 by conventional means, such as by use of mechanical fasteners. An incandescent light bulb 22, such as a 60 watt light bulb, is shown extending downward from an aperture 28 in the ceiling 8, and is shielded from inadvertent contact by an operator by a heat shield 24. The heat shield 24 is constructed of stamped stainless steel sheet metal and has an upper edge that is bent to be horizontal to provide a mounting flange, with holes therethrough that receive fasteners 26, in the form of rivets, for mounting of the heat shield 24 to the ceiling 8 on the underside of the upper unit 6.

As may be seen in FIG. 5, connected to the upper side of the panel that forms the ceiling 8 of the cavity 15 is a socket 30, which is aligned or concentric with the aperture 28 through which the incandescent bulb 22 extends. Indeed, the screw-in base of the incandescent light bulb 22 extends upward through the aperture 28 and is threadably received in the socket 30. The socket 30 is connected to a bracket 32, which in turn is connected to the ceiling 8 by additional fasteners 34, in the form of rivets, for mounting the bracket 32 to the ceiling 8 on the underside of the upper unit 6. The socket 30 receives power via wires 36 that are connected to a control panel 38 for the popcorn machine 2. The control panel 38 ultimately receives power from the power cord 16, via wiring within the popcorn machine 2.

Unfortunately, the incandescent bulb 22 and sheet metal heat shield 24 are not particularly attractive. They also consume a fairly large amount of space within the cavity, and present obstacles to quick and efficient cleaning of the interior surfaces of the cavity 15, such as the ceiling 8 or the inner surfaces of the side panels 14. Especially when hot, the bulb 22 and shield 24 could pose a risk of burning or cutting an operator that is not being careful.

In addition, the prior art popcorn machine 2, with a downward extending incandescent light bulb 22, poses a risk of glass breakage, which could result in a hazard wherein broken glass could fall into the cavity 15 that collects the popped corn. This would result in a significant cleaning task, while also causing unnecessary downtime for the machine. Moreover, it is no secret that incandescent bulbs are not particularly energy efficient. A typical 60 watt bulb produces around 800 lumens and about 85 Btu's per hour of heat. If additional heat is not needed in the cavity, then the heat ultimately is wasted energy. Incandescent light bulbs also are not particularly durable, with a filament that is fairly easily broken, and a life span that may average around 1200 hours of use. In addition, when in a typical mounting, such as is shown in the prior art popcorn machine 2, the light bulb 22 extends through the aperture 28 that unfortunately also permits the air in the machine, which can include oily vapors and humidity, to circulate up into the upper unit 6. This infiltration into the upper unit 6 generally is not good for the cleanliness or longevity of the equipment.

Turning to FIGS. 6-14, one sees an example of a popcorn machine 102 and components for the machine that provide an example of the types of advantageous apparatus and methods that may include the inventive subject matter herein.

The popcorn machine 102 includes a housing 104, having an upper unit 106 having a lower surface 108, and a base unit 110 having an upper surface 112, as well as a plurality of side panels 114, which together define a cavity 115. The base and upper units 106, 110 may be made of suitable materials, which may include stamped steel, such as stainless steel, aluminum, plastics or any other materials that perform well in environments that are subjected to heat and food products.

The side panels 114 of this example preferably include at least one transparent portion and may be constructed of a durable material that is suitable for contacting a food product, such as glass or plastic. However, it will be appreciated that any of the side panels in their entirety, or any portions thereof, may be non-transparent and may be constructed of glass, plastic or other suitable materials, such as aluminum, stainless steel, or the like. In this example, the side panels 114 are joined together in the corners by a plurality of corner columns that extend vertically between the base unit 110 and upper unit 106. It will be understood that popcorn machines could utilize side panels that close only a portion of a side of a machine but that still help define the cavity 115. Also, of note, a pair of hinged doors that serve as the side panels on the front of the popcorn machine 102, and that are associated with the opening for the operator to reach into the cavity 115, have been removed from the popcorn machine 102 for enhanced viewing of the other components.

In this example popcorn machine 102, the lower surface 108 of the upper unit 106 serves as a ceiling of the cavity 115, while the upper surface 112 of the base unit 110 serves as a floor of the cavity 115. A power cord 116 brings electricity to the popcorn machine 102 and is connected to the base unit 110.

Within the cavity 115 is a kettle assembly 118 for heating oil to cook the corn. The kettle assembly 118 hangs from kettle supports 120. The kettle assembly 118 and kettle supports 120 may be constructed of stainless steel or other suitable materials. The kettle supports 120 are connected to the upper unit 106 at the ceiling 108 of the cavity 115 by conventional means, such as by use of mechanical fasteners, which may include screws, rivets, welding or other suitable means of connection.

In this example popcorn machine 102, an LED light source 122 is shown in the form of a bulb having color changing and sound reactive features, while being able to produce suitable light. For instance, a commercially available LED light source in the form of a bulb ranging from 3-8 watts may be suitable, although the light intensity may be a matter of choice. Thus, the LED light source 122 is configured and adapted to selectively provide at least two colors of light and to react to sound, such as by turning on or off in response to encountering a sound. Such bulbs are commercially available from multiple companies. It will, however, be appreciated that the LED light source may be of a type that provides a single color of light, or that is not configured to react to sounds, while still providing many of the advantages discussed herein.

The advantageous LED light source 122 of this example is shown being located in a flush mounting configuration relative to the ceiling 108, at the aperture 128 through the ceiling 108. Thus, the LED light source 122 is configured to shine light into the cavity 115, but due to its relatively compact size and length, and its low energy dissipation in the form of heat, it may be flush mounted, so as to conceal all but a portion of the face and the lens of the LED light source 122, if desired. Accordingly, the LED light source 122 may be installed and used without the need for a heat shield, or the concern for the potentially hazardous conditions that can occur when an operator is working around a hot incandescent light bulb, a heat lamp or a sheet metal heat shield, while providing a closed area around the face of the LED light source.

As may be seen in FIG. 10, connected to the upper side of the panel that forms the ceiling 108 of the cavity 115 is a socket 130, which is aligned or concentric with the aperture 128, over which the LED light source 122 is flush mounted. It will, however, be understood that an LED light source of a different shape or size, such as a different bulb configuration or LED strip lighting, may alternatively reside adjacent the upper unit 106, in a position entirely above the ceiling 108, extending down through an aperture in the ceiling and into the cavity 115, or being connected below the ceiling 108, while still achieving a number of the advantages of using an LED light source discussed herein. Indeed, multiple LED light sources could be positioned in association with corresponding apertures through the ceiling 108, or even mounted to the underside of the ceiling 108, such as with LED strip or tape lighting, if a more even distribution of light is desired, or if there is a desire to provide multiple, coordinated lighting effects.

The particular LED light source 122 shown in this example happens to conveniently include a screw-in base that is similar to that of an incandescent light bulb. Thus, in this example, the LED light source 122 is threadably received in the socket 130, which can be a socket of similar construction to that of a prior art machine. The socket 130 is connected to a bracket 132, which in turn may be connected to the ceiling 108 or to other components or side portions of the upper unit 106, such as by additional fastening means, including rivets, screws, welding or other suitable means (not shown). It will, however, be appreciated that the LED light source could be of a different configuration that does not have a screw-in base, such as with LED strip lighting, and would then need to be accommodated by a suitable socket or other electrical connector, and appropriate connection either above or below the ceiling 108 of the cavity 115.

In the example shown, the LED light source 122 is connected to a power source for the popcorn machine 102. The LED light source 122 is connected to the socket 130, which in turn, is connected via wires 136 to a control panel 138 for the popcorn machine 102. The control panel 138 ultimately receives power from the power cord 116, via wiring within the popcorn machine 102. The power cord 116 may be plugged into and receive electricity from a suitable wall socket.

It can be readily seen in the various front and side views that the use of the LED light source 122, with its flat face and being mounted flush with the lower surface or ceiling 108 of the upper unit 106 mounting to the ceiling 108, provides a particularly sleek and attractive appearance for the ceiling panel 108, free from the obstructions and hazards posed in the prior art by use of an incandescent bulb or heat lamp and a heat shield. This presents a unique opportunity for convenient cleaning within the cavity 115 of the popcorn machine 102. For instance, because of the cool temperatures associated with operation of an LED light source, the bulb 122 is at most warm to the touch and may be cleaned immediately after use. Moreover, the area is much more accessible and the dirt and oily residue no longer have crevices and other areas or surfaces to cling to that would be associated with a heat shield. Such areas and surfaces are particularly bothersome and can be difficult to clean in the prior art device. The lack of a heat shield and bulb also enhances the ability of an operator to freely reach through the machine to clean the interior surfaces of the cavity 115, such as the ceiling 108 and side panels 114.

With a flush mounting or relatively low profile, and use of thicker and/or less breakable materials than an incandescent light bulb, the LED light source 122 is particularly advantageous and helps to avoid breakage. Moreover, an LED light source, regardless of its configuration, is far more efficient and has much greater durability than an incandescent light bulb. For instance, the light produced by a typical 60 watt incandescent light bulb 22 may be replaced by an LED light source that uses 5-8 watts. In addition, an LED light source should produce roughly 5% or less of the heat of an incandescent light bulb that produces comparable light or lumens. The reduction in heat improves safety, while an LED light source also is more durable, with low sensitivity to low temperatures, to humidity, to on/off cycling and to jarring or bumping. With an estimated average life span of approximately 50,000 hours, roughly 40 times that of an incandescent light bulb, an LED light source also effectively should last the life of the popcorn machine. The durability and life span of an LED light source should help reduce machine downtime, as well as the time required for cleaning. Over the life of a popcorn machine, this could be quite significant.

In addition, if flush mounted to the ceiling 108, the LED light source also may close the aperture 128 in the ceiling 108 and prevent oily vapors and humidity from entering into the upper unit 106 through the aperture 128. Alternatively, even if an LED light source is used that extends downward through an aperture in the ceiling 108, such as the aperture 128, the relatively cool operating temperature of an LED light source will permit use of a gasket or seal to otherwise close the area around the portion of the LED light source that would extend through the aperture in the ceiling.

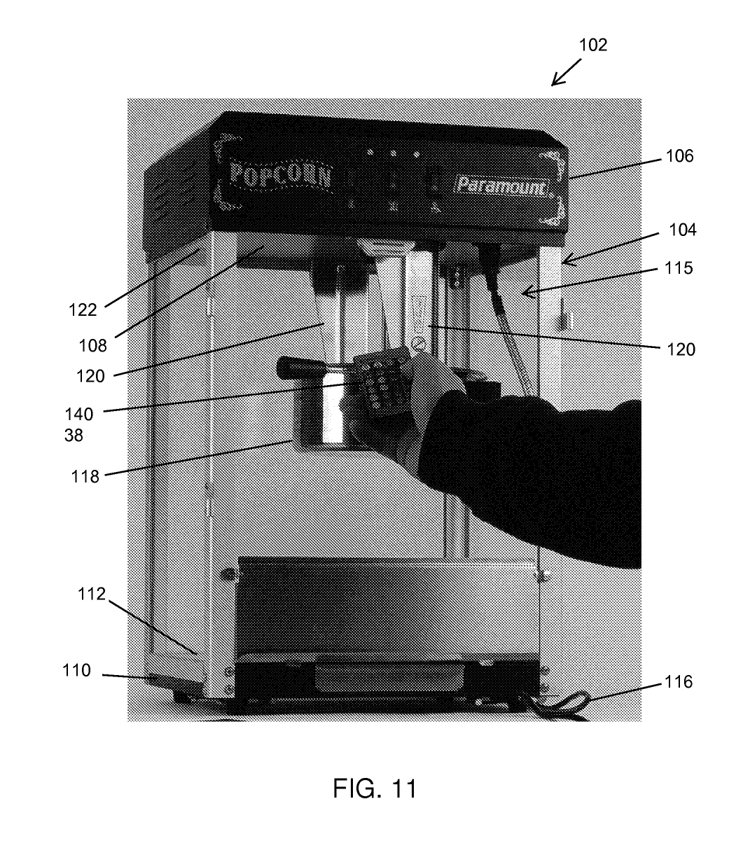

The lighting system disclosed herein may be used to provide lighting effects for a popcorn machine. For example, with the popcorn machine 102 shown in FIGS. 6-14, an LED light source, such as LED light source 122, is connected to an upper unit 106 of the popcorn machine 102. Power is provided to the LED light source 122, as described above, via the power cord 116 and wiring to the control panel 138 and through the wires 136 that are connected to the socket 130 that receives the LED light source 122. The LED light source 122 then may be manipulated by an operator by using a remote control device, such as is shown in FIGS. 11 and 14, which may be purchased with some commercially available LED light sources.

For instance, an operator may aim a remote control device 140 at the LED light source 122, as shown in FIG. 11, and depress any of the selected buttons 142 on the remote control device 140 to achieve a variety of desired lighting effects. For example, the operator may simply depress a button to set the LED light source 122 to send a signal to the LED light source which receives the signal and may provide at least one color of light. Alternatively, the operator may choose to use the remote control device 140 to set the LED light source 122 to provide a plurality of colors of light. The plurality, or at least two colors may be controlled to change abruptly or to fade from one to another. The operator also may select to have the LED light source 122 provide light continuously or to flash. If the LED light source includes a sound reactive feature, the operator may select the feature to have the LED light source react to sounds. Given the sounds generated when popping corn, this can produce a lighting effect that is somewhat similar to a strobe light, but which is tailored to the actual sounds created by the popping corn. It will be appreciated that a variety of lighting effects may be employed to provide entertainment or enjoyment not previously experienced with popcorn machines in the prior art, while also providing the numerous other aforementioned advantages.

It will be appreciated that popcorn machines and components for popcorn machines that are constructed in accordance with the present disclosure may be provided in various configurations individually or in combinations. Any variety of suitable materials of construction, configurations, shapes and sizes for the components and methods of connecting the components and shipping the components may be utilized to meet the particular needs and requirements of an end user. It will be apparent to those skilled in the art that various modifications can be made in the design and construction of such popcorn machines without departing from the scope or spirit of the claimed subject matter, and that the claims are not limited to the preferred embodiments illustrated herein.

What is claimed is:

1. A popcorn machine comprising:
an upper unit spaced from and above a base unit;
a plurality of side panels that extend between the upper and base units and define a cavity;
at least one LED light source within the popcorn machine and connected to the upper unit, wherein the LED light source provides light to the cavity.

2. A popcorn machine in accordance with claim 1, wherein the LED light source further comprises an LED light bulb.

3. A popcorn machine in accordance with claim 1, wherein the LED light source further comprises a color changing feature that produces at least two colors of light.

4. A popcorn machine in accordance with claim 1, wherein the LED light source further comprises a sound reactive feature.

5. A popcorn machine in accordance with claim 1, wherein the LED light source further comprises a threaded base portion configured to be screwed into a socket that is configured for use with an incandescent light bulb or heat lamp.

6. A popcorn machine in accordance with claim 1, wherein the LED light source stays cool enough during use to permit touching by an operator.

7. A popcorn machine in accordance with claim 1, wherein a lower surface of the upper unit is without obstruction by a heat shield in the vicinity of the LED light source.

8. A popcorn machine in accordance with claim 1, wherein the LED light source is connected to a power source for the popcorn machine.

9. A popcorn machine in accordance with claim 1, wherein the LED light source is responsive to a signal generated by a remote control device.

10. A popcorn machine in accordance with claim 1, wherein the LED light source is configured for mounting flush with a lower surface of the upper unit.

11. A popcorn machine in accordance with claim 10, wherein the flush mounting provides a closed area around a face of the LED light source.

12. A method of providing lighting effects for a popcorn machine comprising the steps of:
providing an LED light source connected to an upper unit of the popcorn machine;
providing power to the LED light source; and
setting the LED light source to provide at least one color of light.

13. A method of providing lighting effects for a popcorn machine in accordance with claim 12, wherein the step of setting the LED light source to provide at least one color of light further includes setting the LED light source to provide a plurality of colors of light.

14. A method of providing lighting effects for a popcorn machine in accordance with claim 12, wherein the step of setting the LED light source to provide at least one color of light further includes setting the LED light source to provide the at least one color of light in reaction to sounds.

15. A popcorn machine providing lighting effects comprising:
a housing further comprising an upper unit spaced from and above a base unit, and a plurality of side panels that together with the upper and base units define a cavity; and
at least one LED light source configured to shine light into the cavity.

16. A popcorn machine in accordance with claim 15, wherein the LED light source is positioned adjacent the upper unit.

17. A popcorn machine in accordance with claim 15, wherein the LED light source is positioned entirely above a lower surface of the upper unit.

18. A popcorn machine in accordance with claim 15, wherein the LED light source is adapted to selectively provide at least two colors of light.

19. A popcorn machine in accordance with claim 15, wherein the LED light source further comprises a sound reactive feature.

20. A popcorn machine in accordance with claim 15, wherein the LED light source is responsive to a signal generated by a remote control device.
